(19) United States
(12) Patent Application Publication
(10) Pub. No.: US 2014/0226465 A1
(43) Pub. Date: Aug. 14, 2014

(54) COMMUNICATION MODEM, ELECTRICAL PRODUCT, AND METHOD FOR CONTROLLING SAME

(71) Applicant: LG ELECTRONICS INC., Seoul (KR)

(72) Inventors: Bongmun Jang, Seoul (KR); Junho Ahn, Seoul (KR); Daegeun Seo, Seoul (KR); Munseok Seo, Seoul (KR)

(21) Appl. No.: 14/131,300

(22) PCT Filed: Mar. 13, 2013
(86) PCT No.: PCT/KR2013/002003

§ 371 Date: Apr. 23, 2014

(30) Foreign Application Priority Data
Mar. 15, 2012 (KR) 10-2012-0026777

(51) Int. Cl. H04M 11/06; H04L 12/24

(52) U.S. Cl. CPC H04M 11/06; H04M 11/068; H04L 41/0668
USPC 370/228; 375/222

(57) ABSTRACT

Provided is an electric product. The electric product includes: a communication modem including a printed circuit board; a first communication unit installed at the printed circuit board and performing communication by using a first communication type; and a second communication unit installed at the printed circuit board and performing communication by using a second communication type different from the first communication type; a control unit transmitting/receiving a signal to/from the communication modem; and a load receiving power and controlled by the control unit; wherein the first communication unit and the second communication unit are installed at different corners of the printed circuit board.

### TECHNICAL FIELD

The present disclosure relates to a communication modem, an electric product, and a method for controlling the same.

### BACKGROUND ART

In general, electric products equipped in homes include washing machines, refrigerators, cooking appliances, or cleaner. Typical electric products perform their original functions but cannot receive information from the outside.

Recently, as a communication component is installed to an electric product, the electric product may communicate with other products.

However, if a specific communication type of a communication element is equipped in an electric product, the electric product may not communicate with a product including a different type of a communication element.

### DISCLOSURE OF THE INVENTION

### Technical Problem

Embodiments provide a communication modem and electric product having communication performance improved by a plurality of communication units of different communication types, and a method for controlling the same.

Embodiments also provide a communication modem and electric product minimizing communication interference between a plurality of communication units, and a method for controlling the same.

### Technical Solution

In one embodiment, a communication modem includes: a printed circuit board; a first communication unit installed at the printed circuit board and performing communication by using a first communication type; and a second communication unit installed at the printed circuit board and performing communication by using a second communication type different from the first communication type, wherein the first communication unit and the second communication unit are installed at different corners of the printed circuit board.

In another embodiment, an electric product includes: a communication modem including a printed circuit board; a first communication unit installed at the printed circuit board and performing communication by using a first communication type; and a second communication unit installed at the printed circuit board and performing communication by using a second communication type different from the first communication type; a control unit transmitting/receiving a signal to/from the communication modem; and a load receiving power and controlled by the control unit; wherein the first communication unit and the second communication unit are installed at different corners of the printed circuit board.

In further another embodiment, an electric product includes a method of controlling an electric product including a plurality of communication modems performing communication by using different communication types. The method includes: turning on the plurality of communication modems; determining whether a communication failure condition between the plurality of communication modems is satisfied; and when the communication failure condition is satisfied, one communication modem among the plurality of communication modem is turned off or data of the plurality of communication modems are transmitted through a time division method.

In still further another embodiment, provided is a method of controlling an electric product including a plurality of communication modems performing communication by using different communication types. The method includes: turning on the plurality of communication modems; determining whether a communication failure condition between the plurality of communication modems is satisfied; and when the communication failure condition is satisfied, data of the plurality of communication modems are transmitted through a time division method.

In still further another embodiment, provided is a method of controlling an electric product including a plurality of communication modems performing communication by using different communication types. The method includes: turning on the plurality of communication modems; determining whether a communication failure condition between the plurality of communication modems is satisfied; and when the communication failure condition is satisfied, one communication modem among the plurality of communication modem is turned off.

In still further another embodiment, an electric product includes: a communication modem including a printed circuit board; a first communication unit installed at the printed circuit board and performing communication by using a first communication type; and a second communication unit installed at the printed circuit board and performing communication by using a second communication type different from the first communication type; a control unit transmitting/receiving a signal to/from the communication modem; and a load receiving power and controlled by the control unit; wherein one communication unit of the each communication unit maintains an ON state and another communication unit maintains an OFF state, and when an ON condition of the other communication unit is satisfied, the other communication unit is turned on.

### Advantageous Effects

According to an embodiment of the present invention, since a communication modem includes a plurality of communication units of different communication types, communication may be improved.

Additionally, since a control is performed by a communication modem to prevent communication interference between a plurality of communication units, at least one communication unit may perform communication without communication interference.

### BRIEF DESCRIPTION OF THE DRAWINGS

FIG. 1 is a block diagram illustrating a network system according to a first embodiment of the present invention.

FIG. 2 is a view illustrating a communication modem according to a first embodiment of the present invention.

FIG. 3 is a flowchart illustrating a method of controlling a communication modem according to a second embodiment of the present invention.

FIG. 4 is a flowchart illustrating a method of controlling a communication modem according to a third embodiment of the present invention.

### MODE FOR CARRYING OUT THE INVENTION

Hereinafter, embodiments of the present invention will be described in more detail with reference to the accompanying drawings. However, the scope of the present invention is not limited to suggested embodiments, and those skilled in the art may easily suggest other embodiments within the scope of the present invention.

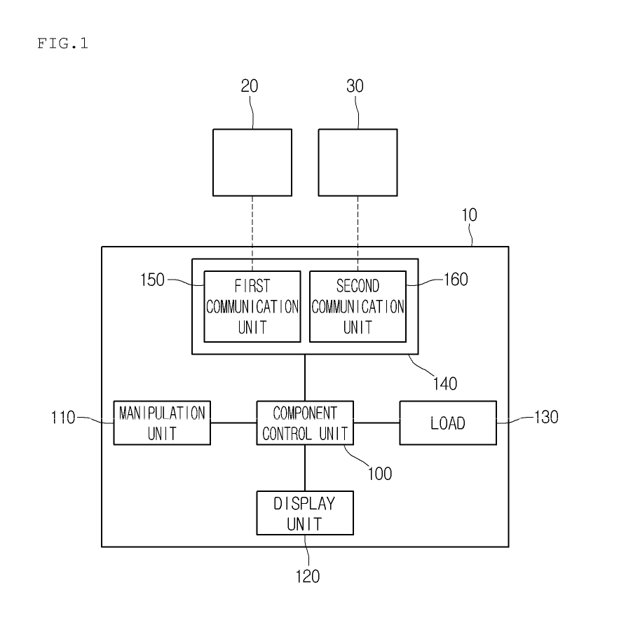

FIG. 1 is a block diagram illustrating a network system according to a first embodiment of the present invention.

Referring to FIG. 1, the network system may include an electric product 10 and a plurality of components 20 and 30 communicating with the electric product 10.

The plurality of components 20 and 30 may include a first component 20 performing communication by using a first communication modem and a second component 30 performing communication by using a second communication modem having a different type from the first communication modem.

The first communication modem may be a Wi-Fi modem and the second communication modem may be a zigbee modem.

The electric product 10 may include a component control unit 100 controlling a function of the electric product 10, a manipulation unit 110 inputting an operation command of the electric product 10, a display unit 120 displaying operation information of the electric product 10, a load 130 operating by receiving power, and a communication modem 140 communicating with the plurality of components 20 and 30.

In more detail, the communication modem 140 may include a first communication unit 150 and a second communication unit 160. The first communication unit 150 may be a Wi-Fi modem and the second communication unit 160 may be a zigbee modem. That is, the communication modem is integrated with a plurality of communication modems performing communication by using different communication types.

Accordingly, the communication modem 140 may communicate with the first component 20 through the first communication unit 150. Moreover, the communication modem 140 may communicate with the second component 30 through the second communication unit 160.

In general, since a communication standard for transmitting/receiving specific information is predetermined, according to the present invention, the communication modem includes a plurality of communication units performing communication through different communication types, so that the communication modem is available for a plurality of communication standards and various information may be transmitted.

Furthermore, according to the present invention, since information that cannot be received by one communication unit is received by another communication unit, communication possibility may be increased. For example, the first communication unit 150 may receive an update program of the second communication unit 160.

Additionally, although a communication available distance is limited according to a communication modem, according to the present invention, the communication available distance may be extended.

In addition, since the communication modem includes different types of communication units according to the present invention, interference may occur during a communication process. Such a communication interference phenomenon may occur because each of the communication units 150 and 160 uses a broad channel bandwidth instead of one frequency, i.e., one channel.

The communication interference phenomenon may be a big issue when each of the communication units 150 and 160 uses a frequency of a different band.

Therefore, a method of minimizing the communication interference phenomenon is suggested additionally.

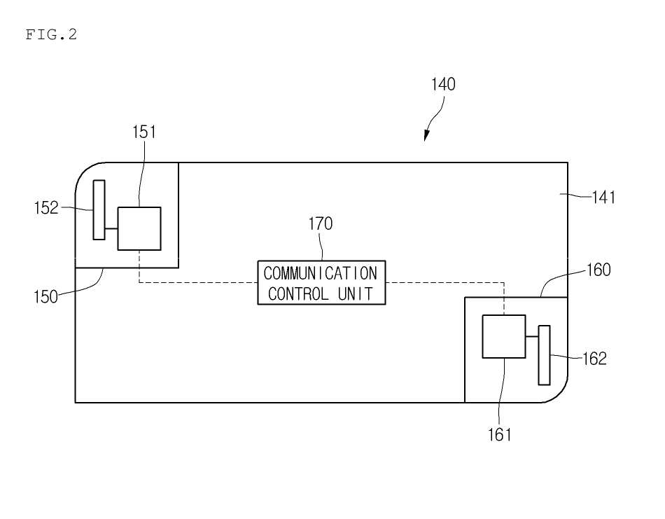

FIG. 2 is a view illustrating a communication modem according to a first embodiment of the present invention.

Referring to FIG. 2, the communication modem 140 may include a printed circuit board 141, and a first communication unit 150 and a second communication unit 160 installed at the printed circuit board 141.

The communication modem 140 may further include a communication control unit 170 controlling each of the first communication unit 150 and the second communication unit 160.

The first communication unit 150 may be a Wi-Fi modem as mentioned above. The first communication unit 150 may include a Wi-Fi chip 151 and a first antenna 152. Since a basic configuration of the first communication unit 150 is implemented by typical technologies, its detailed description is omitted. Hereinafter, a component for reducing a communication interference phenomenon of the second communication unit 160 will be mainly described. For example, each of the communication units 150 and 160 may include a chip antenna and a dipole antenna.

The second communication unit 160 may be a zigbee modem as mentioned above. The second communication unit 160 may include a zigbee chip 161 and a second antenna 162. Since a basic configuration of the second communication unit 160 is implemented by typical technologies, its detailed description is omitted. Hereinafter, a component for reducing a communication interference phenomenon of the first communication unit 150 will be mainly described.

Also, this embodiment does not limit the number and types of the antennas.

In order to prevent a communication interference phenomenon between the first communication unit 150 and the second communication unit 160, the first communication unit 150 and the second communication unit 160 may be installed at different corners of the printed circuit board 141. For example, the first communication unit 150 and the second communication unit 160 may be installed at points where a mutual distance is maximized in the printed circuit board 141. That is, the printed circuit board 141 is typically formed in a polygonal form. The first communication unit 150 may be installed at a first corner of the printed circuit board 141 (a portion where one vertex of the printed circuit board is positioned), and the second communication unit 160 may be installed at a second corner diagonal to the first corner of the printed circuit board 141. The positions of the first corner (e.g., the upper left) and the second corner (e.g., the bottom right) may be clearly understood with reference to FIG. 2.

By a physical distance between the two communication units, a communication interference phenomenon therebetween may be minimized.

Furthermore, the antennas 152 and 162 configuring the communication units respectively may be disposed adjacent to the vertex of each corner. That is, a distance between the antennas 152 and 162 may be greater than that between the Wi-Fi chip 151 and the zigbee chip 161.

Additionally, the corners respectively corresponding to the communication units 150 and 160 may be rounded in the printed circuit board 141. Moreover, a pattern for connecting each installed component is formed on the printed circuit board 141, and at this point, a pattern of a portion where each of the antenna 152 and 162 may be formed curved.

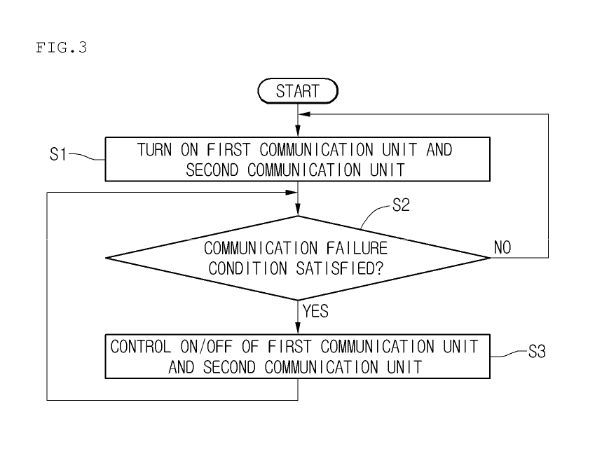

FIG. 3 is a flowchart illustrating a method of controlling a communication modem according to a second embodiment of the present invention.

Referring to FIGS. 2 and 3, once power is supplied to the communication modem 140, the first communication unit 150 and the second communication unit 160 may be turned on in operation S1.

The communication modem 140 may receive power from the electric product 10 or an additional battery.

Then, the communication modem 140, in particular, the communication control unit 170, determines whether communication fault conditions are satisfied between each of the communication units 150 and 160 in operation S2.

In this embodiment, a determination is made on whether the communication fault conditions are satisfied on the basis of at least one of a plurality of determination conditions described below.

First, a first determination condition is that whether a communication channel of the first communication unit 150 and a communication channel of the second communication unit 160 overlap each other. That is, the communication control unit 170 may determine whether a center frequency of a communication channel of each of the communication units 150 and 160 is identical to each other or whether a portion of each band overlaps each other. The case that a center frequency of a communication channel of each of the communication units 150 and 160 is identical to each other or a portion of each communication band overlaps each other satisfies the first determination condition.

A second determination condition is a Received Signal Strength Input (RSSI). That is, the communication control unit 170 may convert an RF signal of a frequency for each channel received through each of the communication units 150 and 160 into a voltage level to detect the RSSI. The case that the RSSI of each of the communication units 150 and 160 is lower than a specific standard level satisfies the second determination condition. At this point, the standard level may be identically or differently set by each of the communication units 150 and 160.

A third determination condition is an error rate for a received packet or an error rate for a transmitted packet. The communication control unit 170 may examine an error rate of a packet received through each of the first communication unit 150 and the second communication unit 160. Additionally, the communication control unit 170 may recognize an error rate of a packet transmitted through each of the first communication unit 150 and the second communication unit 160 by receiving a feedback from the components 20 and 30. Then, the case that an error rate of each of the communication units 150 and 160 exceeds a reference value satisfies the third determination condition. At this point, the reference value may be identically or differently set by each of the communication units 150 and 160.

A fourth determination condition is a re-transmission rate of a packet. The communication control unit 170 may recognize a re-transmission rate when each of the communication units 150 and 160 re-transmits a packet due to due to a failure after transmitting the packet. Then, the case that a packet re-transmission rate of each of the communication units 150 and 160 exceeds a reference value satisfies the fourth determination condition. At this point, the reference value may be identically or differently set by each of the communication units 150 and 160.

When it is determined in operation S2 that the communication failure condition is satisfied, the communication control unit 170 controls ON/OFF of the first communication unit 160 and the second communication unit 170 in operation S3.

For example, a priority between the communication units 150 and 160 is determined so that a communication unit having a high priority is maintained to be turned on and a communication unit having a lower priority is maintained to be turned off. At this point, the priority may be predetermined when the communication modem 140 is manufactured. For example, when the first communication unit 150 is set to a first priority, if the communication failure condition is satisfied, the second communication unit 160 may be turned off. Also, when a predetermined time elapses, the second communication unit 160 may be turned on and the first communication unit 150 may be turned off. Of course, a determined priority may be changed.

As another example, when the predetermined time elapses, the second communication unit 160 may be turned on while the first communication unit 150 is turned on. Then, the method returns to operation S2. Also, as another example, after the second communication unit 160 is turned off, the second communication unit 160 may be turned on if an on time zone of the second communication unit 160 is satisfied.

Moreover, a priority between the communication units 150 and 160 may be determined by each time zone or according to an operation state of the electric product. Moreover, a priority between the communication units 150 and 160 may be determined by a priority of transmitted/received information. For example, power information may be determined as a priority.

Moreover, when it is determined in operation S2 that the communication failure condition is not satisfied, the communication control unit 170 controls the first communication unit 160 and the second communication unit 170 to maintain their ON statuses.

According to this embodiment, when the communication failure condition is not satisfied, communication is performed through the plurality of communication units, and when the communication failure condition is satisfied, since only one communication unit among the plurality of communication units maintains its ON state, a communication interference phenomenon may be minimized during a communication process.

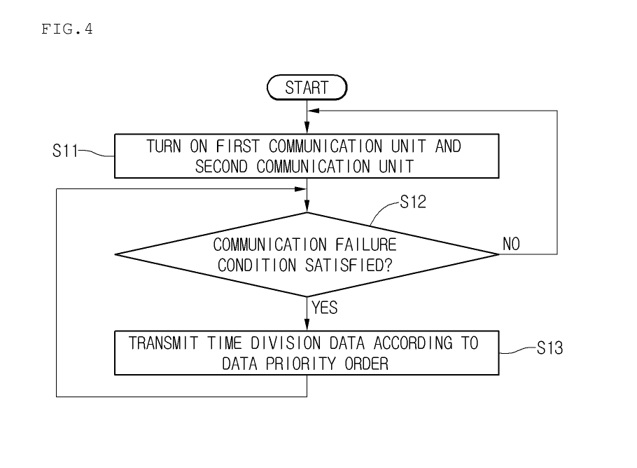

FIG. 4 is a flowchart illustrating a method of controlling a communication modem according to a third embodiment of the present invention.

Referring to FIG. 4, once power is supplied to the communication modem 140, the first communication unit 150 and the second communication unit 160 may be turned on in operation S11.

The communication modem 140 may receive power from the electric product 10 or an additional battery.

Then, the communication modem 140, in particular, the communication control unit 170, determines whether communication fault conditions are satisfied between each of the communication units 150 and 160 in operation S12.

In this embodiment, a determination is made on whether the communication fault conditions are satisfied on the basis of at least one of the plurality of determination conditions described above.

When it is determined in operation S12 that the communication failure condition is satisfied, the communication control unit 170 controls each of the first communication unit 160 and the second communication unit 170 to transmit data through a time division method in operation S13.

For example, a data priority may be determined by a priority between the communication units 150 and 160. If the second communication unit 160 is a first priority, it transmits data first and in this state. Also, data for the transmission of the first communication unit 150 may maintain their standby state and after the data transmission of the second communication unit 160 is completed, the data of the first communication unit 160 may be transmitted.

According to this embodiment, when the communication failure condition is not satisfied, communication is performed through each of the plurality of communication units, and when the communication failure condition is satisfied, since data are transmitted through the time division method, a communication interference phenomenon may be minimized during a communication process.

The second and third embodiments describe a method of controlling a communication modem installed at a single printed circuit board like the first embodiment, but unlike this, when each communication unit is installed at an additional position of the electric product, the control methods of the second and third embodiments may be identically applied.

As another embodiment, a plurality of communication units are not turned on simultaneously. That is, one communication unit may maintain an ON state and another communication may maintain an OFF state. Also, when an ON condition of another communication unit is satisfied, the other communication may be turned on. In this case, when the other communication modem is turned on, the one communication may maintain an ON state or may be turned off.

1. A communication modem comprising:
a printed circuit board;
a first communication unit installed at the printed circuit board and performing communication by using a first communication type; and
a second communication unit installed at the printed circuit board and performing communication by using a second communication type different from the first communication type,
wherein the first communication unit and the second communication unit are installed at different corners of the printed circuit board.

2. The communication modem of claim 1, wherein the first communication unit and the second communication unit are installed at two corner portions forming a diagonal line in the printed circuit board.

3. The communication modem of claim 1, wherein each of the first and second communication units comprises a communication chip and an antenna, and the antenna is disposed at a position adjacent to a vertex of each corner of the printed circuit board.

4. The communication modem of claim 3, wherein a distance between the antenna of the each of the first and second communication units is greater than a distance between the communication chip of each of the first and second communication units.

5. The communication modem of claim 3, wherein a pattern of a portion, where the each antenna is disposed in a pattern formed on the printed circuit board, is curved.

6. An electric product comprising:
a communication modem including a printed circuit board; a first communication unit installed at the printed circuit board and performing communication by using a first communication type; and a second communication unit installed at the printed circuit board and performing communication by using a second communication type different from the first communication type;
a control unit transmitting/receiving a signal to/from the communication modem; and
a load receiving power and controlled by the control unit;
wherein the first communication unit and the second communication unit are installed at different corners of the printed circuit board.

7. The electric product of claim 6, wherein the first communication unit and the second communication unit are installed at two corner portions forming a diagonal line in the printed circuit board.

8. The electric product of claim 6, wherein each of the first and second communication units comprises a communication chip and an antenna, and the antenna is disposed at a position adjacent to a vertex of each corner of the printed circuit board.

9. The electric product of claim 8, wherein a distance between the antenna of the each of the first and second communication units is greater than a distance between the communication chip of the each of the first and second communication units.

10. The electric product of claim 8, wherein a pattern of a portion where the each antenna is disposed in a pattern formed on the printed circuit board is curved.

11. The electric product of claim 8, wherein one communication unit of the first and second communication units maintains an ON state and the other communication unit maintains an OFF state,
wherein when an ON condition of the other communication unit is satisfied, the other communication unit is turned on.

12. A method of controlling an electric product including a plurality of communication modems performing communication by using different communication types, the method comprising:
turning on the plurality of communication modems;
determining whether a communication failure condition between the plurality of communication modems is satisfied; and
when the communication failure condition is satisfied, one communication modem among the plurality of communication modem is turned off or data of the plurality of communication modems are transmitted through a time division method.

13. The method of claim 12, where
a priority between the plurality of communication modems is determined; and
a communication modem having a low priority is turned off first.

14. The method of claim 12, wherein
ON/OFF of each communication modem is determined according to the priority between the plurality of communication modems; and
the priority is determined by each time zone, or according an operation state of an electric product including the plurality of communication modems.

15. The method of claim 12, wherein when an OFF time of a turned-off communication modem elapses by a predetermined time, a turned-on communication modem is turned off and a turned-off communication modem is turned on.

16. The method of claim 12, wherein when an ON condition of a turned-off communication modem is satisfied, the turned-off communication modem is turned on.

17. The method of claim 12, wherein a data transmission order of the each communication modem is determined according to a priority of data.
